(19) United States
(12) Patent Application Publication
(10) Pub. No.: US 2024/0253160 A1
(43) Pub. Date: Aug. 1, 2024

(54) WELDING DEVICE, LIGHT-EMITTING ELEMENT WELDING METHOD, AND DISPLAY DEVICE

(71) Applicant: Tianma Advanced Display Technology Institute (Xiamen) Co., Ltd., Xiamen (CN)

(72) Inventor: William WU, Xiamen (CN)

(73) Assignee: Tianma Advanced Display Technology Institute (Xiamen) Co., Ltd., Xiamen (CN)

(21) Appl. No.: 18/604,794

(22) Filed: Mar. 14, 2024

(30) Foreign Application Priority Data
Nov. 28, 2023 (CN) 202311615890.2

(51) Int. Cl. B23K 26/21; B23K 26/14; B23K 37/04; B23K 101/36

(52) U.S. Cl. CPC B23K 26/21; B23K 26/1464; B23K 37/0435; B23K 2101/36

(57) ABSTRACT

A welding device includes a fixing component, a welding part, and a pressure application component. The fixing component includes a first fixing member and a second fixing member that are spaced apart from each other along a first direction. The welding part is movably disposed relative to the fixing component and is configured to be capable of emitting energy in a direction of a current element to be welded in a device group to be welded. An orthographic projection of the pressure application component on a first work plane, between the first fixing member and the second fixing member, at least partially surrounds an orthographic projection of the welding part on the first work plane, and the pressure application component is configured to emit gas to at least the device group to be welded at a position of the current element to be welded to apply pressure.

### CROSS-REFERENCE TO RELATED APPLICATION

This application claims priority to Chinese Patent Application No. 202311615890.2, filed on Nov. 28, 2023, the disclosure of which is incorporated herein by reference in its entirety.

### TECHNICAL FIELD

The present disclosure belongs to the technical field of electronic products and, in particular, to a welding device, a light-emitting element welding method, and a display device.

### BACKGROUND

Light-emitting diodes (LEDs) are widely used in technical fields such as lighting and display due to their advantages such as a small size, low power, long service life, and high brightness. An LED display has an LED array of individual pixel elements. Compared with the currently widely used display device, the LED display has better contrast, faster response speed, and lower energy consumption.

Since LEDs are individually manufactured in the form of chips with dimensions in the order of microns, during the production of the display device, a large number of LED chips need to be transferred to appropriate positions on a substrate, and the electrodes on the LED chips and the corresponding pads on the substrate are aligned and welded. However, due to the structural limitations of the existing welding device, the welding effect cannot satisfy the requirements.

Therefore, a new welding device, a light-emitting element welding method, and a display device are urgently needed.

### SUMMARY

Embodiments of the present disclosure provide a welding device, a light-emitting element welding method, and a display device. A manner in which a pressure application component is used to apply targeted local pressure on a device group to be welded is adopted so that the difficulty of controlling the parallelism of the press-fit of the device group to be welded can be reduced; and by adjusting the pressure of the gas emitted by the pressure application component, the press-fit pressure of the device group to be welded can be adjusted so that complete contact between two parts to be welded of the device group to be welded can be ensured and a good welding effect can be ensured.

In a first aspect, an embodiment of the present disclosure provides a welding device. The welding device includes a fixing component, a welding part, and a pressure application component. The fixing component is configured to fix a device group to be welded and includes a first fixing member and a second fixing member that are spaced apart from each other along a first direction, where at least one of the first fixing member or the second fixing member is movably disposed along the first direction, and the first fixing member and the second fixing member are capable of approaching or being separated from each other. The welding part is disposed on a side of the fixing component along the first direction and movably disposed relative to the fixing component, where the welding part is configured to be capable of emitting energy in a direction of a current element to be welded in the device group to be welded. The pressure application component is disposed on the side of the fixing component along the first direction and movably disposed relative to the fixing component. In the case where the welding device is in operation, a first work plane is included between the first fixing member and the second fixing member along the first direction, an orthographic projection of the pressure application component on the first work plane at least partially surrounds an orthographic projection of the welding part on the first work plane, and the pressure application component is configured to emit gas to at least the device group to be welded at a position of the current element to be welded to apply pressure.

In a second aspect, an embodiment of the present disclosure provides a light-emitting element welding method. The method includes the following steps: providing a fixing component, where the fixing component includes a first fixing member and a second fixing member that are spaced apart from each other along a first direction, at least one of the first fixing member or the second fixing member is movably disposed along the first direction, the first fixing member and the second fixing member are capable of approaching or being separated from each other, and a first work plane is included between the first fixing member and the second fixing member along the first direction; fixing a device group to be welded by the fixing component, where the device group to be welded includes a light-emitting element to be welded; providing a welding part that emits energy in a direction of a current light-emitting element to be welded in the device group to be welded; and providing a pressure application component, where an orthographic projection of the pressure application component on the first work plane at least partially surrounds an orthographic projection of the welding part on the first work plane, and the pressure application component emits gas to at least the device group to be welded at a position of the current light-emitting element to be welded to apply pressure.

In a third aspect, an embodiment of the present disclosure provides a display device. The display device includes a light-emitting element and a second substrate, where the second substrate includes a signal line and a pad, and the light-emitting element and the pad are welded by using the welding device according to any of the preceding embodiments.

### BRIEF DESCRIPTION OF DRAWINGS

To illustrate technical solutions in embodiments of the present disclosure more clearly, the drawings used in the description of the embodiments of the present disclosure are briefly described below. Apparently, the drawings described below illustrate merely part of the embodiments of the present disclosure, and those of ordinary skill in the art may obtain other drawings based on the drawings described below on the premise that no creative work is done.

FIG. 1 is a sectional diagram of a welding device according to an embodiment of the present disclosure;

FIG. 2 is a structural diagram of a welding device in a working state according to an embodiment of the present disclosure;

FIG. 3 is a structural diagram of a welding device in a working state according to another embodiment of the present disclosure;

FIG. 4 is a structural diagram of a welding device in a working state according to another embodiment of the present disclosure;

FIG. 5 is a structural diagram of a welding part and a pressure application component according to an embodiment of the present disclosure;

FIG. 6 is a schematic diagram of projections of a welding part and a pressure application component on a first work plane according to an embodiment of the present disclosure;

FIG. 7 is a structural diagram of a welding device in a working state according to another embodiment of the present disclosure;

FIG. 8 is a structural diagram of a welding device according to an embodiment of the present disclosure;

FIG. 9 is a structural diagram of a gas adsorption portion according to an embodiment of the present disclosure;

FIG. 10 is a structural diagram of a gas adsorption portion according to another embodiment of the present disclosure;

FIG. 11 is a flowchart of a light-emitting element welding method according to an embodiment of the present disclosure;

FIG. 12 is a sectional diagram of a structure obtained in step S110 in a method for preparing a display panel according to an embodiment of the present disclosure;

FIG. 13 is a sectional diagram of a structure obtained in step S120 in a method for preparing a display panel according to an embodiment of the present disclosure;

FIG. 14 is a sectional diagram of a structure obtained in steps S130 and S140 in a method for preparing a display panel according to an embodiment of the present disclosure;

FIG. 15 is a structural diagram of a second substrate according to an embodiment of the present disclosure;

FIG. 16 is a schematic diagram of the positions of a first projection and a second projection according to an embodiment of the present disclosure;

FIG. 17 is a schematic diagram of the positions of a first projection and a second projection according to another embodiment of the present disclosure;

FIG. 18 is a schematic diagram of the positions of a first projection and a second projection according to another embodiment of the present disclosure;

FIG. 19 is a schematic diagram of the positions of a first projection and a second projection according to another embodiment of the present disclosure; and

FIG. 20 is a structural diagram of a display device according to an embodiment of the present disclosure.

### DETAILED DESCRIPTION

Features and example embodiments in various aspects of the present disclosure are described hereinafter in detail. Details are set forth below to facilitate a thorough understanding of the present disclosure. To those skilled in the art, apparently, the present disclosure may be implemented with no need for some of these specific details. The description of the embodiments hereinafter is intended merely to provide a better understanding of the present disclosure through examples of the present disclosure.

It is to be noted that herein, relationship terms such as first and second are used merely for distinguishing one entity or operation from another and do not necessarily require or imply any such actual relationship or order between these entities or operations. Furthermore, the term “comprising”, “including”, or any other variant thereof is intended to encompass a non-exclusive inclusion so that a process, method, article, or device that includes a series of elements not only includes the expressly listed elements but also includes other elements that are not expressly listed or are inherent to such a process, method, article, or device. In the absence of more restrictions, the elements defined by the statement “including . . . ” do not exclude the presence of additional identical elements in the process, method, article, or device that includes the elements.

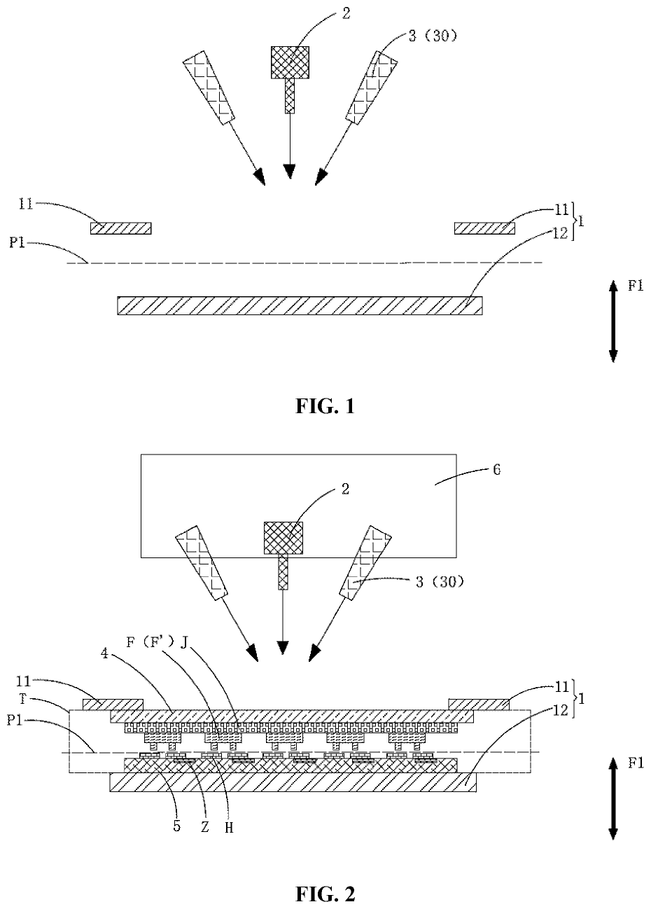

To better understand the present disclosure, a welding device, a light-emitting element welding method, and a display device according to the embodiments of the present disclosure are described in detail below in conjunction with FIGS. 1 to 19.

Referring to FIGS. 1 to 2, FIG. 1 is a sectional diagram of a welding device according to an embodiment of the present disclosure, and FIG. 2 is a structural diagram of a welding device in a working state according to an embodiment of the present disclosure.

An embodiment of the present disclosure provides a welding device. The welding device includes a fixing component 1, a welding part 2, and a pressure application component 3. The fixing component 1 is configured to fix a device group to be welded T and includes a first fixing member 11 and a second fixing member 12 that are spaced apart from each other along a first direction F1, where at least one of the first fixing member 11 or the second fixing member 12 is movably disposed along the first direction F1, and the first fixing member 11 and the second fixing member 12 are capable of approaching or being separated from each other. The welding part 2 is disposed on a side of the fixing component 1 along the first direction F1 and movably disposed relative to the fixing component 1, where the welding part 2 is configured to be capable of emitting energy in a direction of a current element to be welded F in the device group to be welded T. The pressure application component 3 is disposed on the side of the fixing component 1 along the first direction F1 and movably disposed relative to the fixing component 1. In the case where the welding device is in operation, a first work plane P1 is included between the first fixing member 11 and the second fixing member 12 along the first direction F1, an orthographic projection of the pressure application component 3 on the first work plane P1 at least partially surrounds an orthographic projection of the welding part 2 on the first work plane P1, and the pressure application component 3 is configured to emit gas to at least the device group to be welded T at a position of the current element to be welded F to apply pressure.

The welding device provided in the embodiment of the present disclosure includes the fixing component 1, the welding part 2, and the pressure application component 3. At least one of the first fixing member 11 or the second fixing member 12 is movably disposed along the first direction F1, so as to facilitate the installation, replacement, and position adjustment of the device group to be welded T. After the device group to be welded T is fixed by the fixing component 1, the welding part 2 emits energy in the direction of the current element to be welded F in the device group to be welded T so that the current element to be welded F is welded. At the same time, the pressure application component 3 may emit gas to at least the device group to be welded T at the position of the current element to be welded F to apply pressure so that the device group to be welded T at the position of the current element to be welded F can be stressed by the pressure of the gas, two parts to be welded of the device group to be welded T are in close contact with each other, and a good welding effect can be ensured.

In this embodiment, the welding part 2 and the pressure application component 3 are both movably disposed relative to the fixing component 1. In the case where the welding device is in operation, the welding part 2 and the pressure application component 3 can move relative to the fixing component 1 so that the welding part 2 and the pressure application component 3 can move relative to the device group to be welded T fixed by the fixing component 1, and thus the welding part 2 can weld elements to be welded F at different positions of the device group to be welded T. The pressure application component 3 may apply pressure to different positions of the device group to be welded T, and the orthographic projection of the pressure application component 3 on the first work plane P1 at least partially surrounds the orthographic projection of the welding part 2 on the first work plane P1, that is, the pressure application component 3 may cooperate with the welding part 2; and the pressure application component 3 applies targeted local pressure on the welding region of the welding part 2. Compared with the manner of applying pressure on the entire surface in the related art, in this embodiment, a manner in which the pressure application component 3 is used to apply targeted local pressure is adopted so that the difficulty of controlling the parallelism of the press-fit of the device group to be welded T can be reduced; and by adjusting the pressure of the gas emitted by the pressure application component 3, the press-fit pressure of the device group to be welded T can be adjusted so that complete contact between two parts to be welded of the device group to be welded T can be ensured and a good welding effect can be ensured.

It is to be noted that in this embodiment, the fixing component 1 includes the first fixing member 11 and the second fixing member 12 that are spaced apart from each other along the first direction F1, where the first direction F1 may be a horizontal direction or a vertical direction; and the device group to be welded T may be set corresponding to the specific direction of the first fixing member 11 and the second fixing member 12, as long as it is convenient for the welding part 2 and the pressure application component 3 to act on the device group to be welded T. For example, in the case where the first direction F1 is the vertical direction, the corresponding first work plane P1 may be located on a horizontal plane, that is, the device group to be welded T is fixed horizontally. Of course, the actual arrangement of the fixing component 1 and the device group to be welded T may be set based on requirements and is not specifically limited.

In this embodiment, the welding part 2 and the pressure application component 3 may act on the same element to be welded F at the same time so that the element to be welded F is welded.

As shown in FIG. 2, in this embodiment, the device group to be welded T may include a first substrate 4 and a second substrate 5. The first substrate 4 includes light-emitting elements F′, and the second substrate 5 includes signal lines Z and pads H.

Solder may be prepared in advance on the pads H or the electrodes of the light-emitting elements F′, and the pressure application component 3 applies pressure to the first substrate 4 or the second substrate 5 so that the electrodes of the light-emitting elements F′ are in contact with the pads H, the welding part 2 heats the solder on the pads H or the electrodes of the light-emitting elements F′ to make the solder melt, thereby welding the pads H and the electrodes. At the same time, since the gas generated by the pressure application component 3 can take away part of the heat generated during welding, the problem of heat accumulation during the welding process can be relieved, and the welding temperature uniformity control effect can be improved, thereby improving the welding yield.

In an embodiment of the present disclosure, the light-emitting element F′ in this embodiment may be a micro light-emitting diode (microLED) or a mini light-emitting element (Mini LED). The microLED and the Mini LED have the advantages of a small dimension, high luminescence efficiency, and low energy consumption. The dimension of the microLED is less than 50 μm, while the dimension of the Mini LED is less than 100 μm.

It is to be noted that, in addition to the light-emitting elements F′, the device group to be welded T may further include other types of chips, such as driver chips (not shown in the figure). Optionally, the device group to be welded T may include the first substrate 4 and the second substrate 5. The first substrate 4 includes the driver chips, and the second substrate 5 includes the signal lines Z and the pads H. The pressure application assembly 3 applies pressure to the first substrate 4 or the second substrate 5 so that the pins of the driver chips are in contact with the pads H, the welding part 2 heats the solder on the pads H or the pins of the driver chips to make the solder melt, thereby welding the pads H and the pins of the driver chips.

In an embodiment of the present disclosure, the first substrate 4 may be a transfer substrate used for transferring the light-emitting elements F′ from a growth substrate to the second substrate 5 after the light-emitting elements F′ are prepared or may also refer to the growth substrate of the light-emitting elements F′. In an embodiment of the present disclosure, an adhesive layer J is further included between the first substrate 4 and the light-emitting elements F′ to adhere and fix the light-emitting elements F′. After the welding is completed, the connection between the light-emitting elements F′ and the adhesive layer J may be removed.

The second substrate 5 may include only the signal lines Z and the pads H or may include more components such as pixel circuits. Of course, the pixel circuits may also be disposed on the first substrate 4 and are not specifically limited, and the details may be based on the specific type and the preparation process of the light-emitting elements F′.

In an embodiment of the present disclosure, the welding part 2 includes at least one of a laser welding part, an electromagnetic-wave welding part, or an ultrasonic welding part. Any form of the energy emitted by the welding part 2 that can achieve welding of the device group to be welded T without causing damage to the device group to be welded T is suitable. The case where the welding part 2 is the laser welding part is used as an example in the embodiments described below.

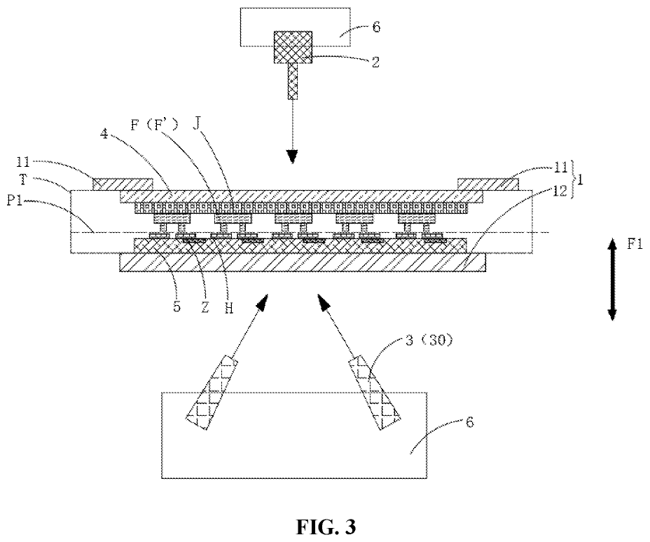

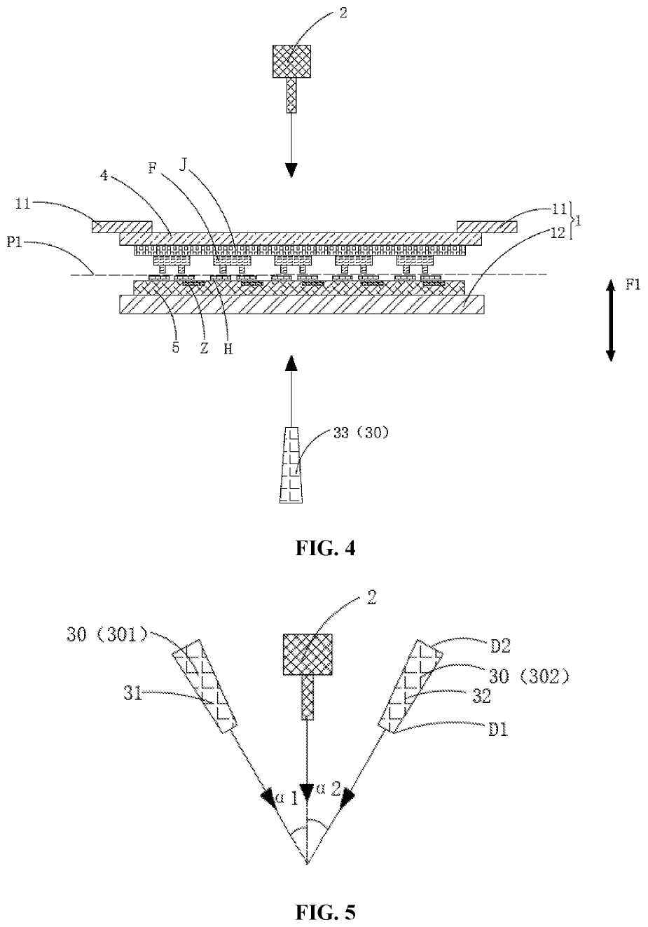

Referring to FIGS. 2 to 4, FIG. 2 is a structural diagram of a welding device in a working state according to an embodiment of the present disclosure, FIG. 3 is a structural diagram of a welding device in a working state according to another embodiment of the present disclosure, and FIG. 4 is a structural diagram of a welding device in a working state according to another embodiment of the present disclosure. In this embodiment, each of the welding part 2 and the pressure application component 3 is disposed on a side of the fixing component 1 along the first direction F1, which means that the welding part 2 and the pressure application component 3 may be located on the same side of the fixing component 1 as shown in FIG. 2 or different sides as shown in FIGS. 3 and 4.

Referring to FIG. 2, the welding part 2 and the pressure application component 3 are disposed on the same side of the first work plane P1 along the first direction F1. In this embodiment, a plane where the first work plane P1 is located is used as the boundary, and the welding part 2 and the pressure application component 3 are located on the same side, so as to facilitate the synchronous movement of the welding part 2 and the pressure application component 3, improve the cooperation effect between the welding part 2 and the pressure application component 3, and ensure that the solder on the pads H or the electrodes of the light-emitting elements F′ can be heated simultaneously by the welding part 2.

In this embodiment, to avoid the welding part 2 and the pressure application component 3 from interfering with each other, the welding part 2 and the pressure application component 3 may be spaced apart from each other in a direction parallel to the first work plane P1. For example, the welding part 2 and the pressure application component 3 may be disposed on a side of the first substrate 4 facing away from the second substrate 5, or the welding part 2 and the pressure application component 3 may be disposed on a side of the second substrate 5 facing away from the first substrate 4.

Referring to FIG. 5, FIG. 5 is a structural diagram of the welding part 2 and the pressure application component 3 according to an embodiment of the present disclosure. In some optional embodiments, the pressure application component 3 includes a nozzle portion 30, and in an extension direction of the nozzle portion 30, the nozzle portion 30 includes a first end D1 and a second end D2 that are opposite to each other, where the first end D1 is configured to emit the gas, the first end D1 is disposed near the welding part 2 relative to the second end D2, and the extension direction of the nozzle portion 30 is inclined relative to an extension direction of the welding part 2.

It is to be understood that in this embodiment, the extension direction of the nozzle portion 30 is inclined relative to the extension direction of the welding part 2, and the first end D1 is disposed near the welding part 2 relative to the second end D2, that is, the gas emitted from the first end D1 may apply pressure to the device group to be welded T at the position of the current element to be welded F, so as to eliminate the following problem: in the case where the welding part 2 and the pressure application component 3 are disposed on the same side, since the welding part 2 and the pressure application component 3 cannot be disposed at the same position, the gas of the pressure application component 3 cannot be directly incident on the device group to be welded T at the position of the current element to be welded F along the first direction F1. Of course, the preceding arrangement in which the extension direction of the nozzle portion 30 is inclined relative to the extension direction of the welding part 2 is not limited to the case where the welding part 2 and the pressure application component 3 are disposed on the same side and may be applied to the case where the welding part 2 and the pressure application component 3 are disposed on two opposite sides of the first work plane P1 along the first direction F1, and no special limitation is made.

In this embodiment, the “inclined arrangement” in which the extension direction of the nozzle portion 30 is inclined relative to the extension direction of the welding part 2 may be understood as follows: the extension direction of the nozzle portion 30 intersects with the extension direction the welding part 2. For example, in the case where the extension direction of the welding part 2 is the same as the first direction F1, an included angle exists between the extension direction of the nozzle portion 30 and the first direction F1.

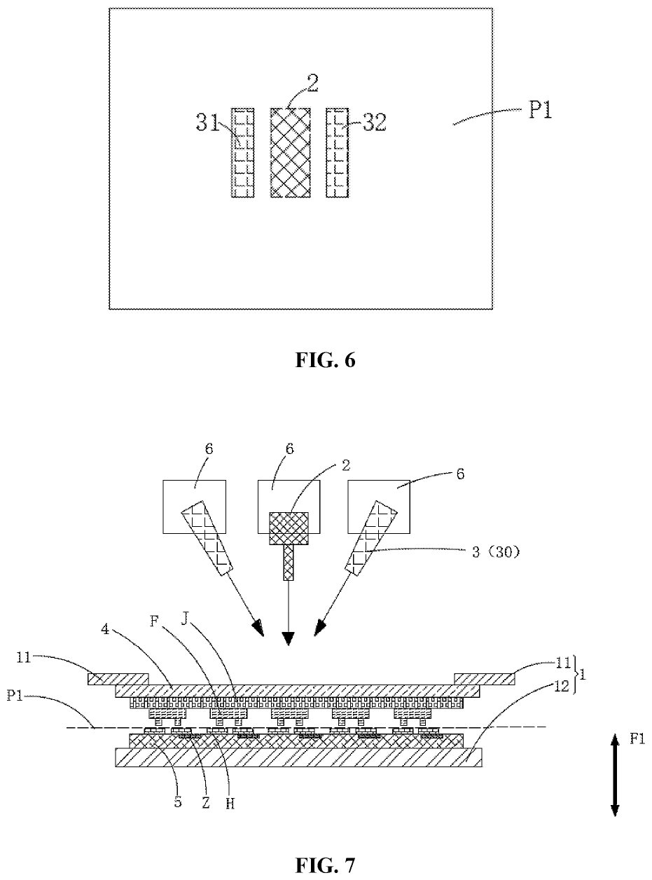

Referring to FIGS. 5 and 6, FIG. 6 is a schematic diagram of projections of the welding part 2 and the pressure application component 3 on the first work plane P1 according to an embodiment of the present disclosure. In some optional embodiments, the pressure application component 3 includes a first pressure application part 31 and a second pressure application part 32 on the same side of the first work plane P1 along the first direction F1, where orthographic projections of the first pressure application part 31 and the second pressure application part 32 on the first work plane P1 are located on two sides of the orthographic projection of the welding part 2 on the first work plane P1, respectively; and the first pressure application part 31 includes a first nozzle portion 301, the second pressure application part 32 includes a second nozzle portion 302, an extension direction of the first nozzle portion 301 is inclined relative to the extension direction of the welding part 2, and an extension direction of the second nozzle portion 302 is inclined relative to the extension direction of the welding part 2.

In this embodiment, the first pressure application part 31 and the second pressure application part 32 may be symmetrical about the welding part 2, so as to uniformly apply pressure to the device group to be welded T on two sides of the welding region of the welding part 2. The extension direction of the first nozzle portion 301 may correspond to the emission direction of the gas emitted by the first nozzle portion 301. Similarly, the extension direction of the second nozzle portion 302 may correspond to the emission direction of the gas emitted by the second nozzle portion 302, and the extension direction of the welding part 2 may correspond to the energy emission direction of the welding part 2. For example, in the case where the welding part 2 is the laser welding part, the extension direction of the laser welding part corresponds to the laser emission direction of the laser welding part.

As shown in FIG. 5, in an embodiment of the present disclosure, the inclination angle of the extension direction of the first nozzle portion 301 relative to the extension direction of the welding part 2 is equal to the inclination angle of the extension direction of the second nozzle portion 302 relative to the extension direction of the welding part 2 so that an included angle α1 between the gas emission direction of the first nozzle portion 301 and the energy emission direction of the welding part 2 is equal to an included angle α2 between the gas emission direction of the second nozzle portion 302 and the energy emission direction of the welding part 2, so as to improve the consistency of the pressure on two sides of the welding region of the welding part 2, thereby avoiding the following problem: the pressure on two sides is inconsistent, affecting the welding effect, and the pressure on two sides of the welding region of the welding part 2, that is, the pressure acting on the first substrate 4 or the second substrate 5 is uneven, causing the first substrate 4 or the second substrate 5 to tilt and deviate.

Referring to FIG. 6, in some optional embodiments, the orthographic projection of the pressure application component 3 on the first work plane P1 is spaced apart from the orthographic projection of the welding part 2 on the first work plane P1.

It is to be understood that in the case where the welding part 2 and the pressure application component 3 are disposed on the same side of the first work plane P1 along the first direction F1, the pressure application component 3 the welding part 2 are required to be spaced apart to facilitate the inclined arrangement of the pressure application component 3 relative to the welding part 2 so that the gas emitted by the pressure application component 3 can be accurately emitted to the corresponding position of the current element to be welded F irradiated by the laser of the welding part 2.

Referring to FIGS. 3 and 4, in some optional embodiments, the welding part 2 and the pressure application component 3 are disposed on two opposite sides of the first work plane P1 along the first direction F1.

It is to be understood that since the welding part 2 and the pressure application component 3 are located on different sides of the first work plane P1, the problem of mutual interference of the positions of the welding part 2 and the pressure application component 3 can be avoided. That is, in this embodiment, the orthographic projection of the pressure application component 3 on the first work plane P1 and the orthographic projection of the welding part 2 on the first work plane P1 may at least partially overlap so that the gas emitted by the pressure application component 3 can be more accurately emitted to the corresponding position of the current element to be welded F irradiated by the laser of the welding part 2.

Referring to FIG. 4, in an embodiment of the present disclosure, the pressure application component 3 includes a third pressure application part 33, where the third pressure application part 33 and the welding part 2 are disposed on two opposite sides of the first work plane P1 along the first direction F1; and the third pressure application part 33 and the welding part 2 at least partially overlap along the first direction F1.

It is to be noted that the two (the first pressure application part 31 and the second pressure application part 32) and the third pressure application part 33 may be provided at the same time or separately, that is, only the first pressure application part 31 and the second pressure application part 32 may be provided, or only the third pressure application part 33 may be provided, so as to adjust the pressure on the device group to be welded T.

In this embodiment, since the third pressure application part 33 and the welding part 2 at least partially overlap along the first direction F1, correspondingly, along the first direction F1, a landing point region of the gas emitted by the third pressure application part 33 on the device group to be welded T at least partially overlap a laser spot of the welding part 2, so as to achieve synchronization of press-fit and laser heating.

Referring to FIG. 2, to drive the welding part 2 and the pressure application component 3 to move relative to the fixing component 1, in some optional embodiments, the welding device further includes drive parts 6, where the welding part 2 and the pressure application component 3 are connected to the same drive part 6.

It is to be understood that since the welding part 2 and the pressure application component 3 are connected to the same drive part 6, to facilitate the connection and reduce the arrangement difficulty, the welding part 2 and the pressure application component 3 are generally disposed on the same side of the first work plane P1 along the first direction F1 and connected to the same drive part 6. The drive part 6 can at least drive the welding part 2 and the pressure application component 3 to move in a direction parallel to the first work plane P1 so that the welding part 2 and the pressure application component 3 can act on the elements to be welded F at different positions.

Referring to FIGS. 3 and 7, FIG. 7 is a structural diagram of a welding device in a working state according to another embodiment of the present disclosure; to facilitate the separate adjustment of the positions of the welding part 2 and the pressure application component 3, the welding part 2 and the pressure application component 3 may be separately connected to different drive parts 6. In this embodiment, the welding part 2 and the pressure application component 3 may be disposed on the same side of the first work plane P1 along the first direction F1, but the welding part 2 and the pressure application component 3 are separately connected to different drive parts 6. It is also feasible that the welding part 2 and the pressure application component 3 are disposed on two opposite sides of the first work plane P1 along the first direction F1, so as to increase the space available for the welding part 2, the pressure application component 3, and the drive parts 6, thereby facilitating the arrangement.

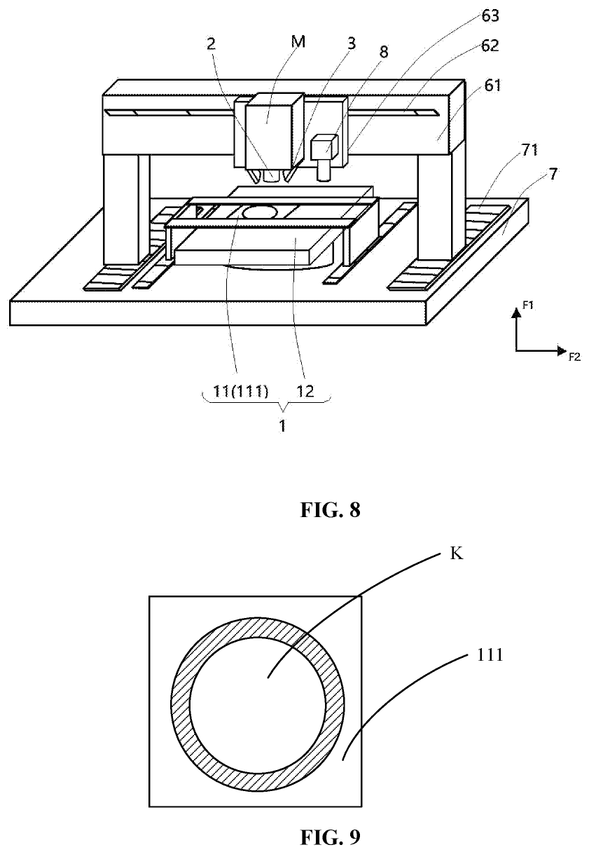

Referring to FIG. 8, FIG. 8 is a structural diagram of a welding device according to an embodiment of the present disclosure; in an embodiment of the present disclosure, the drive part 6 may include a gantry structure, where the gantry structure may be driven by a servomotor (not shown in the figure) and includes a support arm 61, a slide rail 62 disposed on the support arm 61, and a first fixing block 63 slidably connected to the slide rail 62, the welding part 2 and the pressure application component 3 may be directly fixed to the first fixing block 63 or indirectly fixed to the first fixing block 63 through a second fixing block M, and the second fixing block M is movable relative to the first fixing block 63 along the first direction F1.

In an embodiment of the present disclosure, an image acquisition element such as a camera 8 may further be provided on the first fixing block 63 so that the image acquisition element is used to achieve positioning between the first fixing member 11 and the second fixing member 12 or positioning between the welding part 2, the pressure application component 3, and the device group to be welded T.

In an embodiment of the present disclosure, a platform 7 is further included, where the support arm 61, the first fixing member 11, and the second fixing member 12 may all be disposed on the platform 7, multiple rails 71 may be disposed on the platform 7, and the support arm 61, the first fixing member 11, and the second fixing member 12 are separately movable along the tracks 71.

Of course, the specific structural form of the drive part 6 is not limited to the preceding embodiments and may be set according to the actual situations, and no special limitation is made.

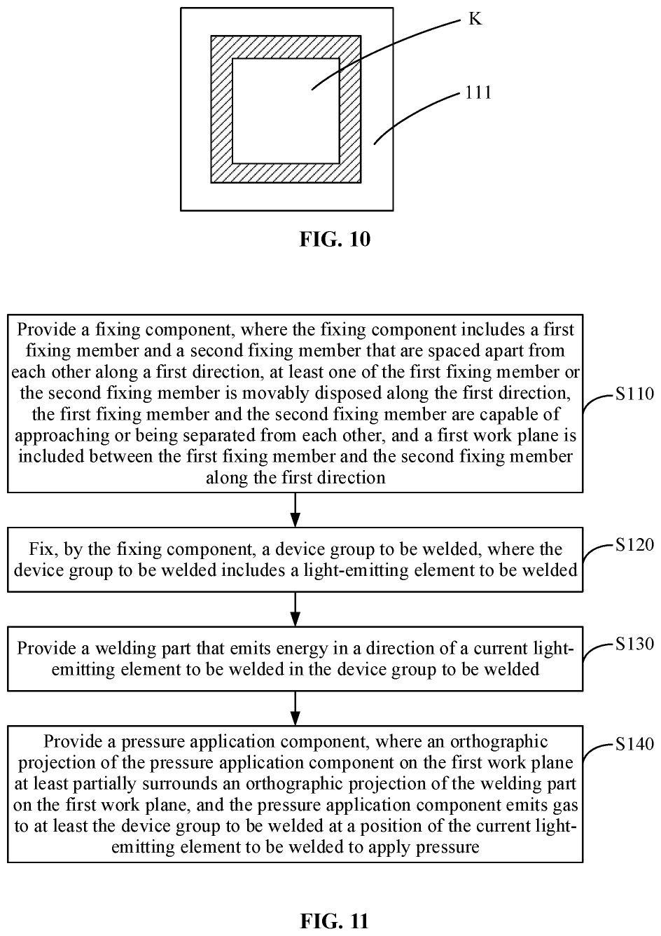

Referring to FIG. 2 and FIGS. 8 to 10, FIG. 9 is a structural diagram of a gas adsorption portion according to an embodiment of the present disclosure, and FIG. 10 is a structural diagram of a gas adsorption portion according to another embodiment of the present disclosure. In some optional embodiments, the first fixing member 11 includes one of a gas adsorption portion 111 or a platform support portion, and the second fixing member 12 includes the other one of the gas adsorption portion 111 or the platform support portion, where the gas adsorption portion 111 is configured to provide an adsorption force, and the platform support portion includes a support plane.

It is to be noted that the gas adsorption portion 111 can adsorb one of the first substrate 4 or the second substrate 5 of the device group to be welded T through the adsorption force. The gas adsorption portion 111 absorbs the first substrate 4 or the second substrate 5 so that the first substrate 4 or the second substrate 5 is convenient to replace; and the platform support portion includes the support plane so that the support plane flatly supports the first substrate 4 or the second substrate 5. For example, in the case where the first substrate 4 includes the light-emitting elements F′, the second substrate 5 includes the signal lines Z and the pads H, and the welding part 2 and the pressure application component 3 are both disposed on the side of the first substrate 4 facing away from the second substrate 5, since the first substrate 4 needs to be replaced after welding is completed, to facilitate the replacement of the first substrate 4, the gas adsorption portion 111 may be used to adsorb and fix the first substrate 4, and the platform support portion is used to support and fix the side of the second substrate 5 facing away from the first substrate 4 so that relatively large deformation of the second substrate 5 under the pressure of the pressure application component 3 due to insufficient strength of the second substrate 5 is avoided, while it can be ensured that a press-fit force exists between the first substrate 4 and the second substrate 5 when the pressure application component 3 blows gas.

In an embodiment of the present disclosure, the gas adsorption portion 111 may include a circular adsorption air channel (as shown in FIG. 9), a square adsorption air channel (as shown in FIG. 10), or the like, as long as a sufficient adsorption force can be ensured.

In this embodiment, the specific structural forms of the first fixing member 11 and the second fixing member 12 may be set according to the specific structures of the first substrate 4 and the second substrate 5, and no special limitation is made.

Referring to FIG. 11, an embodiment of the present disclosure further provides a light-emitting element welding method. The method includes the steps described below.

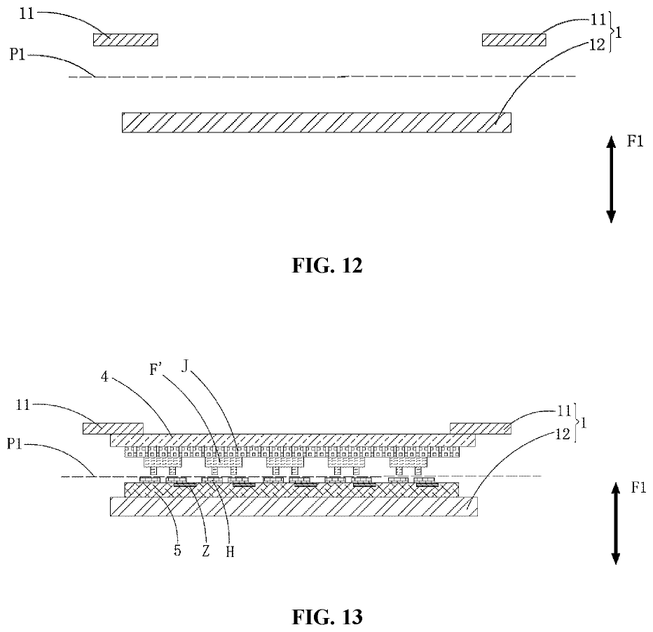

In S110, a fixing component 1 is provided, where the fixing component 1 includes a first fixing member 11 and a second fixing member 12 that are spaced apart from each other along a first direction F1, at least one of the first fixing member 11 or the second fixing member 12 is movably disposed along the first direction F1, the first fixing member 11 and the second fixing member 12 are capable of approaching or being separated from each other, and a first work plane P1 is included between the first fixing member 11 and the second fixing member 12 along the first direction F1 as shown in FIG. 12.

In S120, a device group to be welded T is fixed by the fixing component 1, where the device group to be welded T includes a light-emitting element to be welded F′ as shown in FIG. 13.

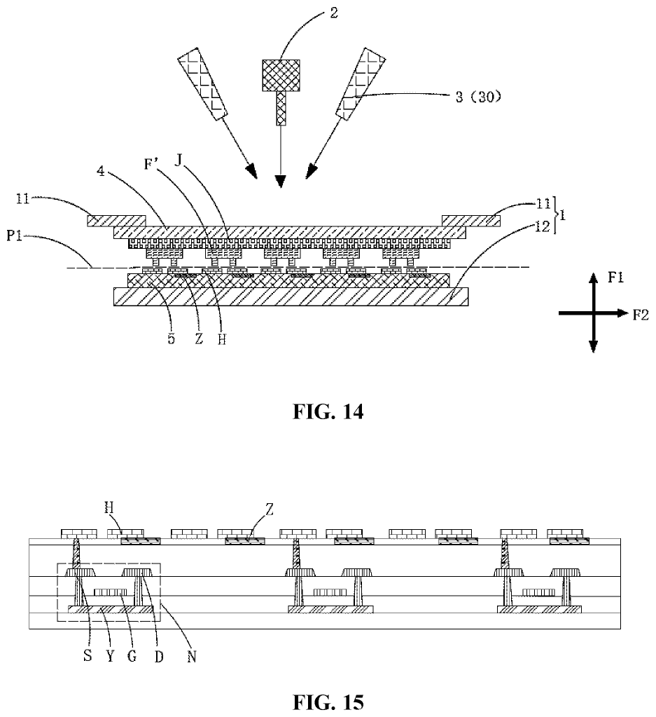

In S130, a welding part 2 that emits energy in a direction of a current light-emitting element to be welded F′ in the device group to be welded T is provided as shown in FIG. 14. The current light-emitting element to be welded F′ corresponds to the element to be welded F in FIG. 2.

In S140, a pressure application component 3 is provided, where an orthographic projection of the pressure application component 3 on the first work plane P1 at least partially surrounds an orthographic projection of the welding part 2 on the first work plane P1, and the pressure application component 3 emits gas to at least the device group to be welded T at a position of the current light-emitting element to be welded F′ to apply pressure as shown in FIG. 14.

In the light-emitting element F′ welding method provided in the embodiment of the present disclosure, after the device group to be welded T is fixed by the fixing component 1, the welding part 2 may emit energy in the direction of the current light-emitting element to be welded F′ in the device group to be welded T so that the current light-emitting element to be welded F′ is welded, and at the same time, the pressure application component 3 may emit gas to at least the device group to be welded T at the position of the current light-emitting element to be welded F′ to apply pressure so that the device group to be welded T at the position of the current light-emitting element to be welded F′ can be stressed by the pressure of the gas, two parts to be welded of the device group to be welded T are in close contact with each other, and a good welding effect can be ensured.

In this embodiment, the welding part 2 and the pressure application component 3 are both movably disposed relative to the fixing component 1. In the case where the welding device is in operation, the welding part 2 and the pressure application component 3 can move relative to the fixing component 1 so that the welding part 2 and the pressure application component 3 can move relative to the device group to be welded T fixed by the fixing component 1, and thus the welding part 2 can weld light-emitting elements to be welded F′ at different positions of the device group to be welded T. The pressure application component 3 may apply pressure to different positions of the device group to be welded T, and the orthographic projection of the pressure application component 3 on the first work plane P1 at least partially surrounds the orthographic projection of the welding part 2 on the first work plane P1, that is, the pressure application component 3 may cooperate with the welding part 2; and the pressure application component 3 applies targeted local pressure on the welding region of the welding part 2. Compared with the manner of applying pressure on the entire surface in the related art, in this embodiment, a manner in which the pressure application component 3 is used to apply targeted local pressure is adopted so that the difficulty of controlling the parallelism of the press-fit of the device group to be welded T can be reduced; and by adjusting the pressure of the gas emitted by the pressure application component 3, the press-fit pressure of the device group to be welded T can be adjusted so that complete contact between two parts to be welded of the device group to be welded T can be ensured and a good welding effect can be ensured.

In step S110, at least one of the first fixing member 11 or the second fixing member 12 is movably disposed along the first direction F1 so that the first fixing member 11 and the second fixing member 12 are capable of approaching or being separated from each other, thereby driving different components of the device group to be welded T fixed by the first fixing member 11 and the second fixing member 12 to move relative to each other.

In step S120, the device group to be welded T may include the first substrate 4 and the second substrate 5, where the first substrate 4 includes the light-emitting elements to be welded F′, and the second substrate 5 includes the signal lines Z and the pads H; the first substrate 4 may be a transfer substrate used for transferring the light-emitting elements F′ from a growth substrate to the second substrate 5 after the light-emitting elements F′ are prepared or may also refer to the growth substrate of the light-emitting elements F′. The second substrate 5 may include only the signal lines Z and the pads H or may include more components such as pixel circuits Z. The pixel circuit Z includes an active layer Y, a gate G, a source S, a drain D, and the like.

As shown in FIG. 15, FIG. 15 is a structural diagram of the second substrate 5 according to an embodiment of the present disclosure. Of course, the pixel circuits may also be disposed on the first substrate 4 and are not specifically limited, and the details may be based on the specific type and the preparation process of the light-emitting elements F′.

In an embodiment of the present disclosure, the first fixing member 11 is configured to fix one of the first substrate 4 or the second substrate 5, and the second fixing member 12 is configured to fix the other one of the first substrate 4 or the second substrate 5.

In step S130, the welding part 2 may include at least one of a laser welding part, an electromagnetic-wave welding part, or an ultrasonic welding part. Any form of the energy emitted by the welding part 2 that can achieve welding of the device group to be welded T without causing damage to the device group to be welded T is suitable. In this embodiment, the welding part 2 is used to emit energy such as a laser to heat the solder on the pads H or the electrodes of the light-emitting elements F′ so that the solder melts, and the light-emitting elements F′ and the signal lines Z are electrically connected through the pads H.

In step S140, the pressure application component 3 can emit gas to the device group to be welded T and use the gas to generate pressure on the first substrate 4 or the second substrate 5 of the device group to be welded T so that the pressed first substrate 4 and the pressed second substrate 5 approach each other, the electrodes of the light-emitting elements F′ are in contact with the pads H, and when the welding part 2 heats and melts the solder on the pads H, the electrodes of the light-emitting elements F′ and the pads H can be closely connected.

It is to be noted that steps S130 and S140 do not represent the sequence of the two; steps S130 and S140 may be performed at the same time, that is, while the pressure application component 3 emits gas to the device group to be welded T, the welding part 2 is used to emit energy in the direction of the current light-emitting element to be welded F′ in the device group to be welded T, and the pressure application component 3 and the welding part 2 cooperate to improve the welding efficiency and yield of the light-emitting element to be welded F′.

In an embodiment of the present disclosure, the welding part 2 includes a laser welding part, the laser welding part is used to emit a laser in the direction of the current light-emitting element to be welded F′ in the device group to be welded T to heat the solder on the pads H or the electrodes of the light-emitting element F′, and at the same time, the pressure application component 3 is used to emit gas to at least the first substrate 4 or the second substrate 5 at the position of the current light-emitting element to be welded F′ to apply pressure so that the current light-emitting element to be welded F′ and the pads H are in contact and welded.

It is to be understood that in this embodiment, the laser welding part and the pressure application component 3 operate at the same time to ensure that when the laser welding part performs laser heating, the pads H and the current light-emitting element to be welded F′ are in close contact with each other.

Whether the pressure application component 3 applies pressure to the first substrate 4 or the second substrate 5 is determined by the position of the pressure application component 3. For example, in the case where the pressure application component 3 is disposed on the side of the first substrate 4 facing away from the second substrate 5, the pressure application component 3 emits gas to the first substrate 4 so that the pressed part of the first substrate 4 approaches the second substrate 5. Similarly, in the case where the pressure application component 3 is disposed on the side of the second substrate 5 facing away from the first substrate 4, the pressure application component 3 emits gas to the second substrate 5 so that the pressed part of the second substrate 5 approaches the first substrate 4.

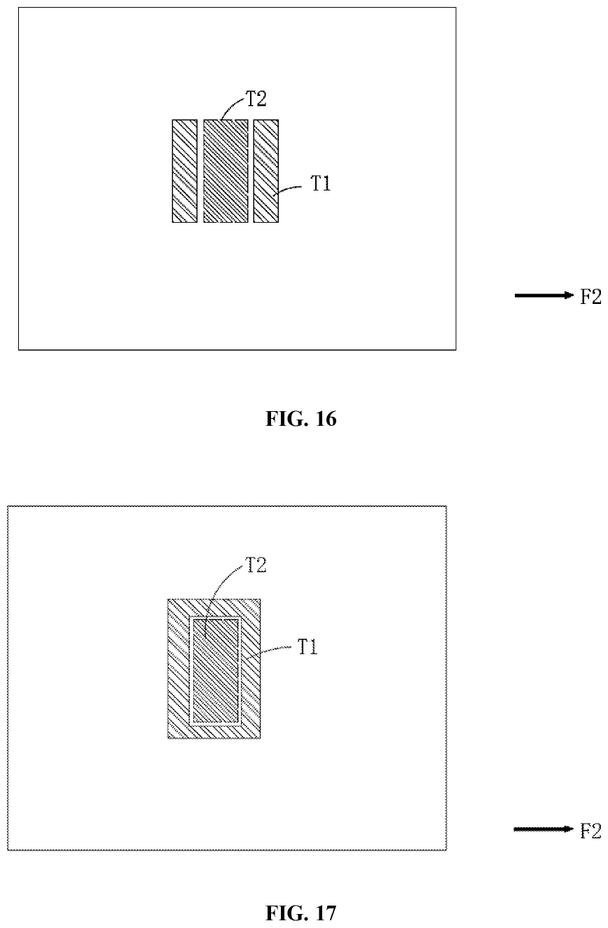

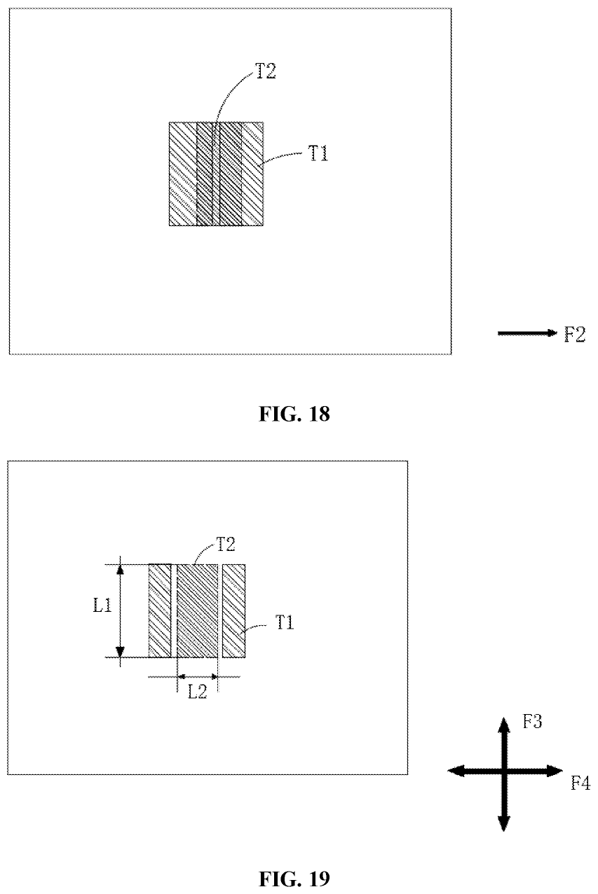

Referring to FIGS. 16 to 18, FIG. 16 is a schematic diagram of the positions of a first projection T1 and a second projection T2 according to an embodiment of the present disclosure, FIG. 17 is a schematic diagram of the positions of the first projection T1 and the second projection T2 according to another embodiment of the present disclosure, and FIG. 18 is a schematic diagram of the positions of the first projection T1 and the second projection T2 according to another embodiment of the present disclosure.

In some optional embodiments, an orthographic projection of a landing point region of the gas emitted by the pressure application component 3 on the first substrate 4 or the second substrate 5 on the first substrate 4 is the first projection T1; and an orthographic projection of a laser spot of the laser emitted by the laser welding part on the first substrate 4 or the second substrate 5 on the first substrate 4 is the second projection T2; where the first projection T1 at least partially surrounds the second projection T2 as shown in FIGS. 16 and 17, the first projection T1 partially surrounds the second projection T2 in FIG. 16, and the first projection T1 completely surrounds the second projection T2 in FIG. 17; or the first projection T1 and the second projection T2 are at least partially coincident as shown in FIG. 18.

In this embodiment, the gas emitted by the pressure application component 3 and the laser spot of the laser welding part may fall on the first substrate 4 at the same time or fall on the second substrate 5 at the same time; or one of the gas or the laser spot may fall on the first substrate 4 and the other one of the gas or the laser spot may fall on the second substrate 5. The first projection T1 and the second projection T2 correspond to a gas landing point region of the pressure application component 3 and a laser spot range of the laser welding part, respectively. The first projection T1 at least partially surrounds the second projection T2, which corresponds to the following: a pressure application range of the pressure application component 3 at least partially surrounds a heating range of the laser welding part. To avoid mutual interference of the airflow on two sides of the laser spot, the pressure application range does not directly correspond to the middle position of the heating range, but surrounds the heating range of the laser welding part so that the gas blows on the peripheral side of the laser spot. At the same time, the gas blows on the peripheral side so that the following is avoided: the airflow directly takes away the heat of the laser, affecting the laser efficiency and increasing the laser power consumption.

Of course, to ensure the position of the light-emitting element F′ corresponding to the laser heating of the laser welding part, the pressure application component 3 is used to keep the pad H at the corresponding position and the current light-emitting element to be welded F′ in close contact with each other, and the first projection T1 and the second projection T2 are at least partially coincident, that is, the pressure application range of the pressure application component 3 and the heating range of the laser welding part are at least partially coincident.

In this embodiment, the range of the landing point region of the gas emitted by the pressure application component 3 on the first substrate 4 or the second substrate 5 may be determined by the dimension of the nozzle portion 30 of the pressure application component 3. By adjusting the cross-sectional size of an air outlet of the nozzle portion 30, the range of the landing point region can be adjusted accordingly.

In some optional embodiments, the laser welding part may be used to emit energy in the direction of the current light-emitting element to be welded F′ in the device group to be welded T, the pressure application component 3 may be used to emit gas to at least the first substrate 4 or the second substrate 5 at the position of the current light-emitting element to be welded F′ to apply pressure, and at the same time, the laser welding part and the pressure application component 3 move along a second direction F2, where the second direction F2 is parallel to the first work plane.

After the laser welding part and the pressure application component 3 complete the welding of the light-emitting element F′ to be welded that can be acted at the corresponding current position, the laser welding part and the pressure application component 3 may move along the second direction F2 to continue welding other light-emitting elements to be welded F′.

In an embodiment of the present disclosure, the drive part 6 may drive the pressure application component 3 and the welding part 2 to move together in a plane parallel to the first work plane P1 so that the pressure application component 3 applies pressure to different positions of the first substrate 4 or the second substrate 5, and at the same time, the welding part 2 emits energy to the light-emitting elements to be welded F′ at different positions.

In this embodiment, the welding part 2 and the pressure application component 3 may be connected to the same drive part 6, or the welding part 2 and the pressure application component 3 may separately be connected to different drive parts 6, and the drive part 6 drives the welding part 2 and the pressure application component 3 to move in the second direction F2, so as to continue welding other light-emitting elements to be welded F′.

Referring to FIG. 16 or 18, in an embodiment of the present disclosure, along the second direction F2, an outer edge of the first projection T1 is spaced apart from an outer edge of the second projection T2 by a predetermined distance; and along an opposite direction of the second direction F2, the outer edge of the first projection T1 is spaced apart from the outer edge of the second projection T2 by a predetermined distance.

It is to be understood that the second direction F2 is the movement direction of the laser welding part and the pressure application component 3; since the laser welding part and the pressure application component 3 move synchronously, to ensure good pressure at the action moment of laser, in this embodiment, the outer edge of the first projection T1 is spaced apart from the outer edge of the second projection T2 by a predetermined distance along the second direction F2 so that it is ensured that when the laser welding part and the pressure application component 3 move along the second direction F2, after the light-emitting elements F′ are pressed on the second substrate 5, the solder on the pads H or the electrodes of the light-emitting elements F′ starts to be heated and melted.

In this embodiment, along the second direction F2, the outer edge of the first projection T1 may exceed the outer edge of the second projection T2 by a predetermined distance, that is, in the second direction F2, the gas pressure application range may be greater than the heating range of the laser.

At the same time, after heating, to prevent the solder from losing pressure before the solder solidifies and causing the chips to be separated from the substrate, the gas pressure application range needs to be increased in an opposite direction of the movement of the laser welding part, that is, along the opposite direction of the second direction F2, the outer edge of the first projection T1 is spaced apart from the outer edge of the second projection T2 by a predetermined distance so that gas can be used to maintain pressure and accelerate cooling of the solder on the solidified pads H or the electrodes of the light-emitting elements F′.

Referring to FIG. 19, FIG. 19 is a schematic diagram of the positions of the first projection T1 and the second projection T2 according to another embodiment of the present disclosure. In some optional embodiments, the laser spot has a first length L1 in a third direction F3 and a second length L2 in a fourth direction F4, where the first length L1 is greater than the second length L2, and the third direction F3 intersects with the fourth direction F4; and in a plane parallel to the first work plane P1, a movement direction of the laser welding part relative to the fixing component 1 is parallel to the fourth direction F4.

Since the first length L1 is greater than the second length L2, when the laser welding part moves along the fourth direction F4 corresponding to the second length L2, the area swept by the laser spot is larger so that the heating efficiency of the laser welding part can be effectively improved. For example, when the laser spot is rectangular, the rectangle has longer sides and shorter sides, the third direction F3 may correspond to the extension direction of the longer sides of the rectangle, and the fourth direction F4 may correspond to the shorter-side direction of the rectangle. When the laser spot moves along the shorter-side direction, that is, the fourth direction F4, the area swept is larger and the heating efficiency is higher. Of course, the laser spot may have another shape and no special limitation is made.

It is to be noted that in this embodiment, the movement direction of the laser welding part relative to the fixing component 1 is parallel to the fourth direction F4, which means that the fourth direction F4 includes the second direction F2 and the opposite direction of the second direction.

In some optional embodiments, the welding part 2 is activated after the pressure application component 3 is activated so that it is ensured that when the welding part 2 heats the solder on the pads H or the electrodes of the light-emitting elements F′, the pads H and the light-emitting elements F′ are in close contact with each other. To prevent the light-emitting elements F′ from being separated from the second substrate 5 when the solder is not solidified, when the laser irradiation stops, the pressure application component 3 needs to continue blowing gas for cooling, that is, the pressure application component 3 needs to be turned off after the welding part is turned off.

In an embodiment of the present disclosure, after the step of providing the pressure application component 3, the following is further included: the welding part 2 stops emitting energy, and the pressure application component 3 is used to emit gas for cooling to the first substrate 4 or the second substrate 5 at the position of the welded light-emitting element F′. The gas emitted by the pressure application component 3 is used to take away the heat generated by welding the device group to be welded T.

Referring to FIGS. 5 and 6, in some optional embodiments, the pressure application component 3 includes the first pressure application part 31 and the second pressure application part 32 on the same side of the first work plane P1 along the first direction F1, where along the first direction F1, orthographic projections of the first pressure application part 31 and the second pressure application part 32 on the first substrate 4 are located on two sides of an orthographic projection of the welding part 2 on the first substrate 4, respectively; the laser welding part and the pressure application component 3 move along the second direction F2, the second direction F2 is parallel to the first work plane, the first pressure application part 31 is disposed on a side of the welding part 2 along the second direction F2, and the second pressure application part 32 is disposed on a side of the welding part 2 along the opposite direction of the second direction F2; and the temperature of gas emitted by the first pressure application part 31 is greater than the temperature of gas emitted by the second pressure application part 32.

In this embodiment, the two pressure application parts (the first pressure application part 31 and the second pressure application part 32) located on the same side may be provided, the first pressure application part 31 is disposed on a side of the laser welding part along the movement direction, the second pressure application part 32 is disposed on a side of the laser welding part along the opposite direction of the movement direction, and the temperature of gas emitted by the first pressure application part 31 is greater than the temperature of gas emitted by the second pressure application part 32 so that in the movement direction of the laser welding part, the first pressure application part 31 blows hot air to preheat the device group to be welded T, thereby reducing the power required for laser processing. In the opposite direction of the movement direction of the laser welding part, the second pressure application part 32 blows cold air to cool down the device group to be welded T so that the solder is rapidly cooled and solidified.

In some optional embodiments, the gas emitted by the pressure application component 3 includes at least one of argon, helium, nitrogen, or compressed air. Argon and helium are inert gases. In this manner, the oxygen content of the welding environment in which the device group to be welded T is located can be reduced, the oxidation impact in the welding process can be reduced, and the welding yield can be improved. Nitrogen with relatively low cost can also reduce the oxygen content of the welding environment in which the device group to be welded T is located and reduce the oxidation effect in the welding process. Compressed dry air (CDA) is the air compressed by an external force. Compressed air is easy to transport, has no special harmful properties, and is low in cost.

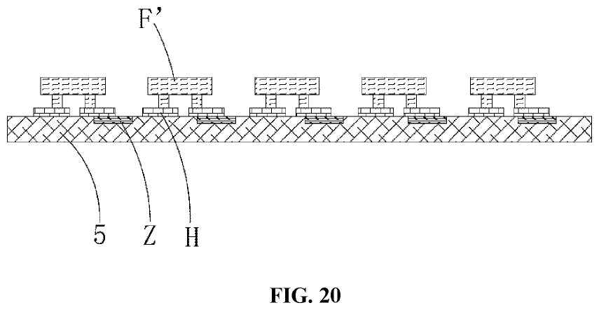

Referring to FIG. 20, FIG. 20 is a structural diagram of a display device according to an embodiment of the present disclosure. The embodiment of the present disclosure further provides a display device. The display device includes the light-emitting elements F′ and the second substrate 5, where the second substrate 5 includes the signal lines Z and the pads H, and the light-emitting elements F′ and the pads H are welded by using the welding device according to any of the preceding embodiments.

The light-emitting element F′ may be a microLED or a Mini LED. The first substrate 4 may be a transfer substrate used for transferring the light-emitting elements F′ from a growth substrate to the second substrate 5 after the light-emitting elements F′ are prepared or may also refer to the growth substrate of the light-emitting elements F′. Therefore, in the process of forming the display device, the light-emitting elements F′ need to be separated from the first substrate 4 so that only the light-emitting elements F′ and the second substrate 5 remain in the display device. The second substrate 5 may include only the signal lines Z and the pads H or may include more components such as pixel circuits. Of course, the pixel circuits may also be disposed on the first substrate 4 and are not specifically limited, and the details may be based on the specific type and the preparation process of the light-emitting elements F′.

The preceding are only the embodiments of the present disclosure. Those skilled in the art may clearly understand that for ease and conciseness of description, for the specific working process of the system, modules, and units described above, reference may be made to corresponding processes in the preceding method embodiments and the details are not repeated here. It is to be understood that the scope of the present disclosure is not limited here. Those skilled in the art may easily conceive various equivalent modifications or substitutions within the technical scope of the present disclosure. These modifications or substitutions should fall within the scope of the present disclosure.

Further, it is to be noted that in the example embodiments mentioned in the present disclosure, some methods or systems are described based on a series of steps or devices. However, the present disclosure is not limited to the sequence of the preceding steps. That is to say, the steps may be performed in the sequence mentioned in the embodiments or in a sequence different from the sequence in the embodiments, or several steps may be performed simultaneously.

What is claimed is:

1. A welding device, comprising:
a fixing component configured to fix a device group to be welded and comprising a first fixing member and a second fixing member that are spaced apart from each other along a first direction, wherein at least one of the first fixing member or the second fixing member is movably disposed along the first direction, and the first fixing member and the second fixing member are capable of approaching or being separated from each other;
a welding part disposed on a side of the fixing component along the first direction and movably disposed relative to the fixing component, wherein the welding part is configured to be capable of emitting energy in a direction of a current element to be welded in the device group to be welded; and
a pressure application component disposed on the side of the fixing component along the first direction and movably disposed relative to the fixing component;
wherein in a case where the welding device is in operation, a first work plane is comprised between the first fixing member and the second fixing member along the first direction, an orthographic projection of the pressure application component on the first work plane at least partially surrounds an orthographic projection of the welding part on the first work plane, and the pressure application component is configured to emit gas to at least the device group to be welded at a position of the current element to be welded to apply pressure.

2. The welding device of claim 1, wherein the welding part and the pressure application component are disposed on a same side of the first work plane along the first direction.

3. The welding device of claim 1, wherein the pressure application component comprises a nozzle portion, and in an extension direction of the nozzle portion, the nozzle portion comprises a first end and a second end that are opposite to each other, wherein the first end is configured to emit the gas, the first end is disposed near the welding part relative to the second end, and the extension direction of the nozzle portion is inclined relative to an extension direction of the welding part.

4. The welding device of claim 2, wherein the pressure application component comprises a first pressure application part and a second pressure application part on the same side of the first work plane along the first direction, wherein orthographic projections of the first pressure application part and the second pressure application part on the first work plane are located on two sides of the orthographic projection of the welding part on the first work plane, respectively; and
the first pressure application part comprises a first nozzle portion, the second pressure application part comprises a second nozzle portion, an extension direction of the first nozzle portion is inclined relative to the extension direction of the welding part, and an extension direction of the second nozzle portion is inclined relative to the extension direction of the welding part.

5. The welding device of claim 1, wherein the orthographic projection of the pressure application component on the first work plane is spaced apart from the orthographic projection of the welding part on the first work plane.

6. The welding device of claim 1, wherein the welding part and the pressure application component are disposed on two opposite sides of the first work plane along the first direction.

7. The welding device of claim 6, wherein the pressure application component comprises a third pressure application part, wherein the third pressure application part and the welding part are disposed on the two opposite sides of the first work plane along the first direction; and
the third pressure application part and the welding part at least partially overlap along the first direction.

8. The welding device of claim 1, further comprising drive parts, wherein the welding part and the pressure application component are connected to a same one of the drive parts; or the welding part and the pressure application component are connected to different ones of the drive parts.

9. The welding device of claim 1, wherein the first fixing member comprises one of a gas adsorption portion or a platform support portion, and the second fixing member comprises the other one of the gas adsorption portion or the platform support portion, wherein the gas adsorption portion is configured to provide an adsorption force, and the platform support portion comprises a support plane.

10. The welding device of claim 1, wherein the welding part comprises at least one of a laser welding part, an electromagnetic-wave welding part, or an ultrasonic welding part.

11. A light-emitting element welding method, comprising:
providing a fixing component, wherein the fixing component comprises a first fixing member and a second fixing member that are spaced apart from each other along a first direction, at least one of the first fixing member or the second fixing member is movably disposed along the first direction, the first fixing member and the second fixing member are capable of approaching or being separated from each other, and a first work plane is comprised between the first fixing member and the second fixing member along the first direction;
fixing a device group to be welded by the fixing component, wherein the device group to be welded comprises a light-emitting element to be welded;
providing a welding part that emits energy in a direction of a current light-emitting element to be welded in the device group to be welded; and
providing a pressure application component, wherein an orthographic projection of the pressure application component on the first work plane at least partially surrounds an orthographic projection of the welding part on the first work plane, and the pressure application component emits gas to at least the device group to be welded at a position of the current light-emitting element to be welded to apply pressure.

12. The light-emitting element welding method of claim 11, wherein the device group to be welded comprises a first substrate and a second substrate, wherein the first substrate comprises the light-emitting element to be welded, and the second substrate comprises a signal line and a pad; and
the first fixing member is configured to fix one of the first substrate or the second substrate, and the second fixing member is configured to fix the other one of the first substrate or the second substrate.

13. The light-emitting element welding method of claim 12, wherein
the welding part comprises a laser welding part, wherein the laser welding part is used to emit a laser in the direction of the current light-emitting element to be welded in the device group to be welded, and at the same time, the pressure application component is used to emit the gas to at least the first substrate or the second substrate at the position of the current light-emitting element to be welded to apply the pressure so that the current light-emitting element to be welded and the pad are in contact with each other and welded.

14. The light-emitting element welding method of claim 13, wherein an orthographic projection, on the first substrate, of a landing point region of the gas emitted by the pressure application component on the first substrate or the second substrate is a first projection; and
an orthographic projection, on the first substrate, of a laser spot of the laser emitted by the laser welding part on the first substrate or the second substrate is a second projection;
wherein the first projection at least partially surrounds the second projection; or the first projection and the second projection are at least partially coincident.

15. The light-emitting element welding method of claim 14, further comprising:
emitting, by the laser welding part, the energy in the direction of the current light-emitting element to be welded in the device group to be welded, emitting, by the pressure application component, the gas to at least the first substrate or the second substrate at the position of the current light-emitting element to be welded to apply the pressure, and at the same time, controlling the laser welding part and the pressure application component to move along a second direction, wherein the second direction is parallel to the first work plane;
wherein along the second direction, an outer edge of the first projection is spaced apart from an outer edge of the second projection by a predetermined distance; and
along an opposite direction of the second direction, the outer edge of the first projection is spaced apart from the outer edge of the second projection by a predetermined distance.

16. The light-emitting element welding method of claim 14, wherein the laser spot has a first length in a third direction and a second length in a fourth direction, wherein the first length is greater than the second length, and the third direction intersects with the fourth direction; and
in a plane parallel to the first work plane, a movement direction of the laser welding part relative to the fixing component is parallel to the fourth direction.

17. The light-emitting element welding method of claim 13, further comprising:
activating the welding part after the pressure application component is activated; and/or
turning off the pressure application component after the welding part is turned off.

18. The light-emitting element welding method of claim 13, wherein the pressure application component comprises a first pressure application part and a second pressure application part on a same side of the first work plane along the first direction, wherein along the first direction, orthographic projections of the first pressure application part and the second pressure application part on the first substrate are located on two sides of an orthographic projection of the welding part on the first substrate, respectively;
the method further comprises control the laser welding part and the pressure application component to move along a second direction, wherein the second direction is parallel to the first work plane, the first pressure application part is disposed on a side of the welding part along the second direction, and the second pressure application part is disposed on a side of the welding part along an opposite direction of the second direction;
wherein temperature of gas emitted by the first pressure application part is greater than temperature of gas emitted by the second pressure application part.

19. The light-emitting element welding method of claim 12, wherein
driving, by a drive part, the pressure application component and the welding part to move together in a plane parallel to the first work plane so that the pressure application component applies the pressure at different positions of the first substrate or the second substrate, and at the same time, emitting, by the welding part, the energy to light-emitting elements to be welded at different positions.

20. A display device, comprising a light-emitting element and a second substrate, wherein the second substrate comprises a signal line and a pad, and the light-emitting element and the pad are welded by using a welding device, wherein the welding device comprises:
a fixing component configured to fix a device group to be welded and comprising a first fixing member and a second fixing member that are spaced apart from each other along a first direction, wherein at least one of the first fixing member or the second fixing member is movably disposed along the first direction, and the first fixing member and the second fixing member are capable of approaching or being separated from each other;
a welding part disposed on a side of the fixing component along the first direction and movably disposed relative to the fixing component, wherein the welding part is configured to be capable of emitting energy in a direction of a current element to be welded in the device group to be welded; and
a pressure application component disposed on the side of the fixing component along the first direction and movably disposed relative to the fixing component;
wherein in a case where the welding device is in operation, a first work plane is comprised between the first fixing member and the second fixing member along the first direction, an orthographic projection of the pressure application component on the first work plane at least partially surrounds an orthographic projection of the welding part on the first work plane, and the pressure application component is configured to emit gas to at least the device group to be welded at a position of the current element to be welded to apply pressure.
